(19) United States
(12) Patent Application Publication
(10) Pub. No.: US 2017/0152686 A1
(43) Pub. Date: Jun. 1, 2017

(54) DOOR LATCH STRUCTURE FOR VEHICLE HAVING IMPROVED OPENING RESPONSIVENESS

(71) Applicant: Hyundai Motor Company, Seoul (KR)

(72) Inventor: Hyong-Don Kim, Incheon (KR)

(21) Appl. No.: 15/090,777

(22) Filed: Apr. 5, 2016

(30) Foreign Application Priority Data
Nov. 30, 2015 (KR) 10-2015-0168953

(51) Int. Cl. E05B 79/10; E05B 85/24; E05B 77/36

(52) U.S. Cl. CPC E05B 79/10; E05B 77/36; E05B 85/243

(57) ABSTRACT

A door latch structure for a vehicle is provided and has an improved opening responsiveness. The door latch includes a striker, a main claw member, a pawl, and a pawl lift. Additionally, a sub claw member is further provided. When a vehicle door is closed, the sub claw member applies force in the direction opposite to that in which the striker pushes the main claw member, to reduce the moment of the main claw member, whereby the door is operated more smoothly and quietly when a user attempts to open the door.

### CROSS-REFERENCE TO RELATED APPLICATION

This application claims the priority benefit of Korean Patent Application No. 10-2015-0168953, filed on Nov. 30 2015 in the Korean Intellectual Property Office, the disclosure of which is incorporated herein by reference.

### BACKGROUND

1. Field of the Invention

The present invention relates to a door latch structure for a vehicle, and more particularly, to a door latch structure for a vehicle having an improved opening responsiveness in which a sub claw member is provided to apply force in the direction opposite of that in which a striker pushes a main claw member when a door is closed, to reduce the moment of the main claw member, whereby the door may be operated more smoothly and quietly when a user attempts to open the door.

2. Description of the Related Art

Generally, a vehicle door is provided with a door latch structure for assisting a user in opening or closing the door using a door handle disposed on an exterior surface of a vehicle. A door latch is disposed at a door or a counterpart of the door and maintains the door closed, so that the door is not automatically opened, and prevents the door from inadvertently being opened or closed.

A conventional door latch structure includes a pawl lift lever, which is rotated when a user pulls an exterior door handle, a pawl, which is rotated via the rotation of the pawl lift lever, a claw member, which is normally engaged with the pawl but is disengaged and rotated when the pawl is rotated, and a striker, which is normally restrained by the claw member but is moved and released when the claw member is rotated. Through the sequential operation of the components mentioned above, the opening of the closed door is performed.

Meanwhile, most vehicle doors include a weather strip, which is interposed between the door and a vehicle body and is formed of rubber or sponge, to prevent, for example, water or dust from entering a passenger compartment when the door is closed. As illustrated in FIG. 1, the door is forced outward of the vehicle (e.g., to the outside) by the weather strip (e.g., by the elasticity of the weather strip). Despite the force with which the weather strip pushes the door (hereinafter referred to as “actual reaction force”), the door is maintained closed via the engagement of the claw member and the pawl, and the actual reaction force is equal to and balanced with the force with which the striker pushes the claw member.

The force with which the striker pushes the claw member increases as the actual reaction force described above increases. The increased moment of the claw member generates loud noise and causes a stiff door opening sensation (e.g., responsiveness) as the pawl and the claw member are disengaged when the user opens the door.

FIG. 2 is a graph illustrating the relationship between the actual reaction force and the operating force. As seen from FIG. 2, the moment of the claw member and the operating force increase as the actual reaction force increases, consumption of energy and consequently generation of noise and stiff door opening sensation occur when the door is opened.

However, there is a limitation to the extent to which the actual reaction force of the weather strip may be reduced since the actual reaction force also performs a sealing function to prevent the invasion of dust and water and to prevent wind sound during driving. Therefore, there is a demand for a door latch structure for a vehicle, which is capable of reducing the force applied to the claw member by the striker while maintaining an appropriate actual reaction force, thereby alleviating noise and maintaining a door opening sensation (e.g., responsiveness) when the door is opened.

### SUMMARY

Therefore, the present invention provides a door latch structure for a vehicle, which may reduce the generation of noise and mitigate a stiff door opening responsiveness caused by the actual reaction force with which a weather strip pushes a door when the door is opened.

Technical objects to be achieved by the present invention are not limited to those mentioned above, and other objects may be clearly understood by those skilled in the art from the description given below.

In accordance with the present invention, the above and other objects may be accomplished by the provision of a door latch structure for a vehicle having an improved door opening responsiveness, the door latch structure may include a striker, a main claw member, a pawl, and a pawl lift lever, wherein the door latch structure may further include a sub claw member configured to apply force to the striker in a direction opposite of that in which the striker applies force to the main claw member when a door is closed.

In the present invention, the sub claw member may include a first opening formed in one end (e.g., a first end) thereof to allow the sub claw member to be coupled to the main claw member, and a second opening formed in the other end (e.g., a second end) thereof to allow the sub claw member to be coupled to a door body via a pin fixedly coupled to the door body. In the present invention, the second opening may be formed into an elongated opening to allow the pin to slide in the second opening via rotation of the main claw member.

In addition, the sub claw member may have a rod shape and may remain spaced apart from the striker when the door is open. The sub claw member may be moved to be proximate to the striker as the door is closed, and then may come into contact with the striker to apply force outward of the door when the door is completely closed. Further, the door latch structure may be applied to the door provided with a weather strip.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a view illustrating force applied to a door by a weather strip according to the related art;

FIG. 2 is a graph illustrating the relationship between actual reaction force and operating force according to the related art;

FIGS. 3A to 3C are views illustrating the sequential operation of a door latch structure for a vehicle, which provides an improved door opening responsiveness when the door is opened, in accordance with one exemplary embodiment of the present invention;

FIGS. 4A to 4C are views illustrating the sequential operation of the door latch structure for the vehicle, which provides an improved door closing responsiveness when the door is closed, in accordance with the exemplary embodiment of the present invention; and

FIG. 5 is a graph comparing variation in operating force based on the actual reaction force of a conventional door latch structure for a vehicle with variation in operating force based on the actual reaction force of the door latch structure for the vehicle having an improved door opening responsiveness in accordance with an exemplary embodiment of the present invention.

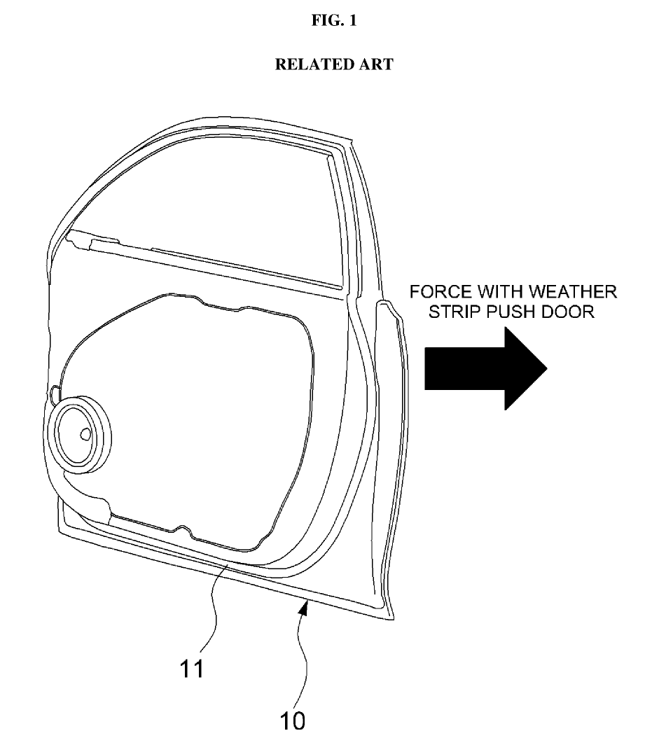

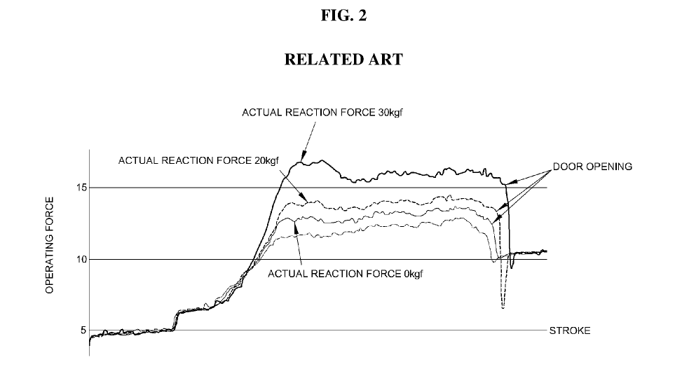

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter, the present invention will be described in detail with reference to the accompanying drawings to allow those skilled in the art to easily practice the present invention. The terms or words used in the specification and claims of the present invention are not interpreted using typical or dictionary limited meanings, and are constructed as meanings and concepts conforming to the technical sprit of the present invention based on the principle that the inventors can appropriately define the concepts of the terms to explain the present invention in the best manner Accordingly, it is to be understood that the detailed description, which will be disclosed along with the accompanying drawings, is intended to describe the exemplary embodiments of the present invention and is not intended to represent all technical ideas of the present invention. Therefore, it should be understood that various equivalents and modifications can exist which can replace the embodiments described in the time of the application.

The terminology used herein is for the purpose of describing particular example embodiments only and is not intended to be limiting. As used herein, the singular forms are intended to include the plural forms as well, unless the context clearly indicates otherwise.

The present invention provides a door latch structure having an improved door opening responsiveness to ensure that a door is more smoothly and quietly operated when a user attempts to open the door, owing to a reduction in the moment of a main claw member. The door latch structure for a vehicle may include a striker 20, a main claw member 30, a pawl 40, and a pawl lift lever 50, and may further include a sub claw member 60, configured to apply force to the striker 20 in the direction opposite to that in which the striker 20 applies force to the main claw member 30 when a door 10 is closed.

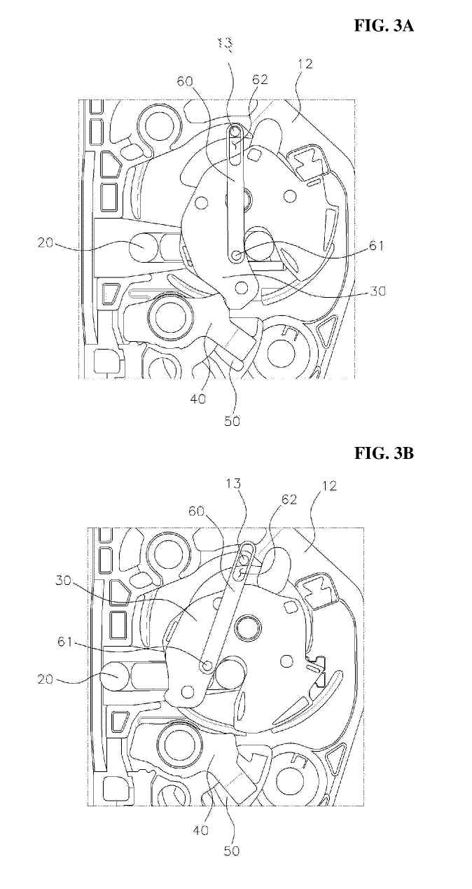

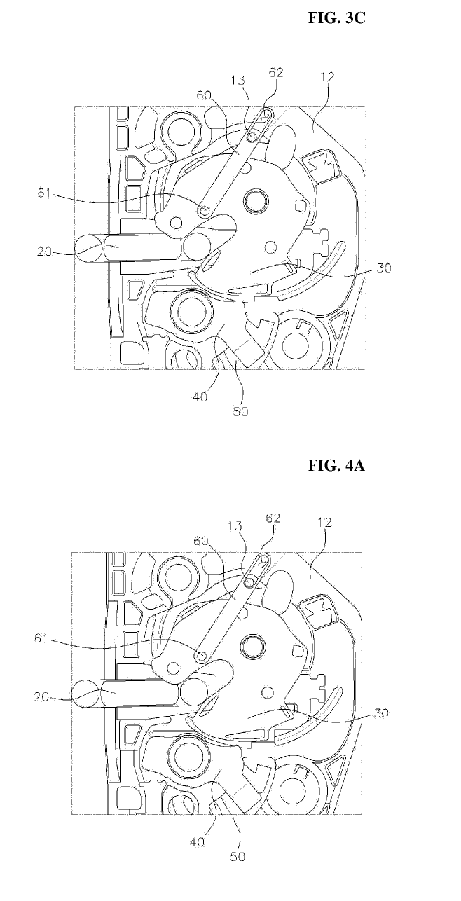

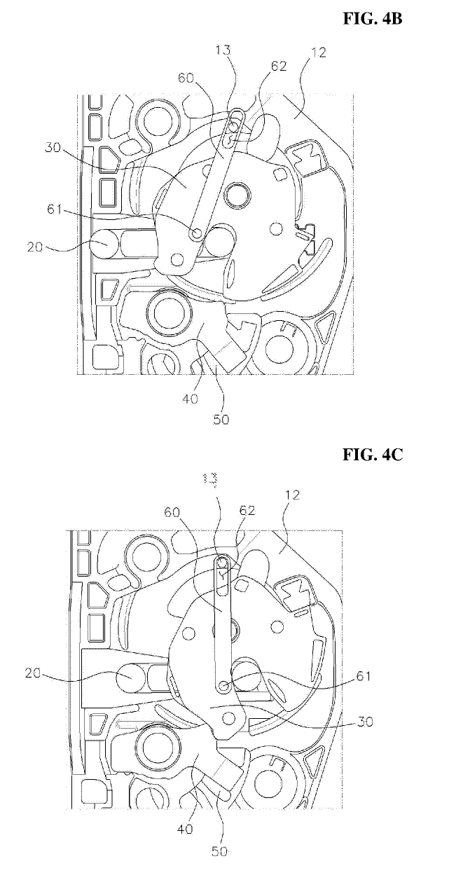

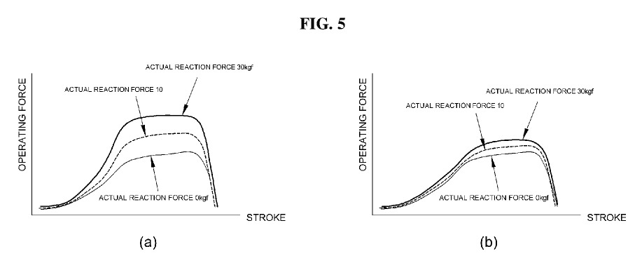

To help the understanding of the above-described configuration, FIGS. 3A to 3C are views illustrating the sequential operation of the door latch structure for a vehicle, which provides an improved door opening responsiveness when the door is opened, in accordance with one exemplary embodiment of the present invention, and FIGS. 4A to 4C are views illustrating the sequential operation of the door latch structure for the vehicle, which provides an improved door closing responsiveness when the door is closed, in accordance with the exemplary embodiment of the present invention.

As illustrated in the drawings, in the present invention, the pawl lift lever 50 may be rotated when an exterior handle of the door 10 is manipulated (e.g., pulled), and the pawl 40 may be rotated via the rotation of the pawl lift lever 50. The main claw member 30, which is normally engaged with the pawl 40 and remains stationary, may be rotated by being disengaged from the pawl 40 when the pawl 40 is rotated. The striker 20 is normally restrained by the main claw member 30, but may be released via the rotation of the main claw member 30.

In addition, in the present invention, the sub claw member 60 may include a first opening 61 formed in a first end thereof to allow the sub claw member 60 to be coupled to the main claw member 30 and a second opening 62 formed in a second end thereof to allow the sub claw member 60 to be coupled to a door body 12 via a pin 13 that is fixedly coupled to the door body 12. With this configuration, the sub claw member 60 may be configured to apply force to the striker 20 in the direction opposite of that in which the striker 20 pushes the main claw member 30 when the door 10 is closed, thereby reducing the actual reaction force.

More specifically, FIG. 3A illustrates the state in which the sub claw member 60 is in contact with the striker 20 when the door 10 is closed and applies force to the striker 20 in the direction opposite to that in which the striker 20 pushes the main claw member 30. Particularly, when the exterior handle is manipulated to open the door 10, as illustrated in FIG. 3B, the pawl 40 may be rotated via the rotation of the pawl lift lever 50, causing the main claw member 30 to be disengaged from the pawl 40. Thereby, the main claw member 30 may begin to rotate to permit the release and movement of the striker 20.

Furthermore, the sub claw member 60 may be configured to continuously push the striker 20 in the direction opposite the actual reaction force, reducing the overall actual reaction force and consequently ensuring reduced noise and an improved door opening responsiveness. As the main claw member 30 gradually rotates, the distance between the sub claw member 60 and the striker 20 gradually increases until the door 10 is opened. FIG. 3C illustrates the door latch structure in the opened state of the door 10.

Contrary to the above description, FIG. 4A illustrates the state in which the door 10 is open. Particularly, the sub claw member 60 and the striker 20 may remain spaced apart from each other. Then, when the door 10 is closed as illustrated in FIG. 4B, the striker 20 may be configured to push the main claw member 30 to cause the main claw member 30 to be rotated to return to an original position. According to the rotation of the main claw member 30, the sub claw member 60 may be moved so be proximate to the striker 20.

Finally, FIG. 4C illustrates the completely closed state of the door 10. The sub claw member 60 may be configured to push the striker 20 in the direction opposite the actual reaction force applied by the striker 20, thereby reducing the actual reaction force. To enable the operation described above, the second opening 62 of the sub claw member 60 may be an elongated opening to allow the pin 13 to slide in the second opening 62 via the rotation of the main claw member 30. In addition, the sub claw member 60 may have a rod shape.

The adoption of this structure provides additional effects of preventing interference with peripheral elements and of enabling a simplified layout setting.

To allow the results of the above-described configuration to be recognized at a glance, FIG. 5 is a graph comparing variation in operating force based on the actual reaction force of a conventional door latch structure for a vehicle with variation in operating force based on the actual reaction force of the door latch structure for the vehicle having an improved door opening sensation in accordance with the present invention.

As will be understood from FIG. 5, the present invention has a feature of reducing variation in operating force based on the magnitude of the actual reaction force by additionally mounting the sub claw member 60 to reduce the force applied to the main claw member 30 by the striker 20, rather than reducing the actual reaction force to overcome limitations caused by the actual reaction force.

In conclusion, as is apparent from the above description, according to the present invention, through the provision of the sub claw member 60 configured to apply force to the striker 20 in the direction opposite to that in which the striker 20 applies force to the main claw member 30 when the door 10 is closed, the door latch structure for the vehicle may reduce noise and mitigate a stiff door opening responsiveness caused by the actual reaction force with which the weather strip 11 pushes the door 10 when the door 10 is opened, thereby advantageously improving the marketability of the vehicle.

In addition, by adding the sub claw member 60 without a substantial or complex change in the configuration of a conventional door latch structure for a vehicle, the door latch structure of the present invention may acquire improvements in terms of manufacturing costs and efficiency due to the use of a smaller number of elements and a simplified manufacturing process.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

1. A door latch structure for a vehicle, comprising:
a pawl lift lever rotated by manipulation of an exterior handle of the vehicle;
a pawl rotated by the rotation of the pawl lift lever;
a main claw member engaged with the pawl and disengaged and rotated therefrom when the pawl is rotated;
a strike moved and released from the main claw member by the rotation of the main claw member; and
a sub claw member configured to apply force to the striker in a direction opposite of that in which the striker applies force to the main claw member when a door is closed,
wherein the sub claw member includes:
a first opening formed in a first end thereof to allow the sub claw member to be coupled to the main claw members; and
a second opening formed in a second end thereof to allow the sub claw member to be coupled to a door body via a pin fixedly coupled to the door body.

2. (canceled)

3. The door latch structure according to claim wherein the second opening is formed into an elongated opening to allow the pin to slide in the second opening via rotation of the main claw member.

4. The door latch structure according to claim 1, wherein the sub claw member has a rod shape.

5. The door latch structure according to claim 1, wherein the sub claw member remains spaced apart from the striker when the door is open and is moved to be proximate to the striker as the door is closed, and then comes into contact with the striker to apply force outward of the door when the door is closed.

6. The door latch structure according to claim 1, wherein the door latch structure is applied to the door provided with a weather strip.
